(19) United States
(12) Patent Application Publication
(10) Pub. No.: US 2022/0332281 A1
(43) Pub. Date: Oct. 20, 2022

(54) Monitor for Usage of Seat Belts

(71) Applicant: Aref Salama, Reading, PA (US)

(72) Inventor: Aref Salama, Reading, PA (US)

(21) Appl. No.: 17/713,019

(22) Filed: Apr. 4, 2022

Related U.S. Application Data
(60) Provisional application No. 63/176,729, filed on Apr. 19, 2021.

(51) Int. Cl. B60R 22/48

(52) U.S. Cl. CPC B60R 22/48; B60R 2022/4816; B60R 2022/4858; B60R 2022/4866

(57) ABSTRACT

A seat belt usage monitor identifies the number of miles driven in a vehicle while the seat belt was connected in comparison with the total number of mile driven in the vehicle. The seat belt usage monitor can be displayed to the operator by a screen incorporated into the seat belt buckle or on a display monitor incorporated into the dashboard of the vehicle. The seat belt usage monitor system will track the number of miles driven while the seat belt is connected and make a comparison to the total number of miles driven by the vehicle. An application program on the operator's cellular phone corresponding to the seat belt usage monitor can be connected to the seat belt usage monitor system to transfer the usage data to the cellphone display, and to permit the function of uploading the data to a recipient selected by the operator, such as the operator's insurance company.

### CROSS-REFERENCE TO RELATED APPLICATIONS

This application claims domestic priority on co-pending U.S. Provisional Patent Application Ser. No. 63/176,729, filed on Apr. 19, 2021, the content of which is incorporated herein by reference.

### FIELD OF THE INVENTION

This invention relates generally to automobiles and other vehicles on which seat belts are deployed, and more particularly, to a monitor to determine the extent of usage of any seat belt deployed in the vehicle.

### BACKGROUND OF THE INVENTION

Automotive vehicles are required to provide seat belts for all passengers within the cabin of the vehicle. Seat belts usage, however, is not explicitly mandated, even though most states have seat belt laws that make the failure to use a seat belt during operation of the vehicle a traffic violation for which fines and costs can be imposed. Many other vehicles, i.e., a motorized, wheeled apparatus that is movable over the surface of the ground by virtue of a power plant, such as an engine, are also provided with seat belts for the safety of the operator. Examples of such other vehicles are lawn mowers, construction vehicles, agricultural tractors, self-propelled harvesters, although such other vehicles are typically equipped with hour meters to record time of usage of the vehicle, rather than odometers that record the distance of travel of the automotive vehicle.

In U.S. Pat. No. 4,844,196, granted on Jul. 4, 1989, to James T. Clevenger, et al, a skid steer loader having an operator's cab positioned between a pair of lift arms and opposing pairs of drive wheels in which the operator's cabin includes an operator's seat and a seat belt associated with the seat, is disclosed. The engagement of the seat belt is a required action before the engine of the skid steer loader can be started. Furthermore, an electronic controller is provided in conjunction with the seat and seat belt switches, the solenoid valves in the hydraulic system and the starter relay in order to require a proper sequencing of the seat and seat belt switches before permitting the starter for the engine to be energized. With this system, the seat belt cannot be engaged until after the seat switch senses the presence of the operator sitting in the seat in order to start the engine. Thus, if the operator leaves the seat belt engaged behind or below the operator, and then turns off the engine, leaves the seat and subsequently returns to the seat, the operator will have to disengage and reengage the seat belt in order to start the engine. Accordingly, seat belt usage is a requirement in this skid steer loader control mechanism.

The automotive vehicle seat belts in U.S. Pat. No. 5,119,407, granted to Cenan Ozmeral on Jun. 2, 1992, are couple electronically to an auxiliary odometer that is driven by the vehicle's standard odometer such that the auxiliary odometer is rotated with the rotation of the standard vehicle odometer to record that the operator's seat belt is engaged. The auxiliary odometer displays on the instrument panel the number of miles that the automotive vehicle has been driven while the operator's seat belt has been engaged. In situations where the operator always wears his seat belt engaged around him or her, the auxiliary odometer would have the same mileage reading as the standard odometer. This analog system can only work with a single seat belt being monitored by the auxiliary seat belt. The remaining seat belts in the vehicle would not be monitored.

In U.S. Pat. No. 9,481,318 issued to John Schmotzer, et al, on Nov. 1, 2016, and owned by Ford Global Technologies, LLC, the seat belt in the automotive vehicle is provided with a display on the seat belt that is coupled to a controller and a transceiver so that the display will receive data through the transceiver and display information based on the data received by the transceiver. Such data is described within the specification as being data related to the seat being occupied, versus the use of the seat belt. In other words, when the seat is occupied, as determined by the seat sensor, and the seat belt has not been engaged, the display could be illuminated as a red color. The display could also be used to reflect the receipt of a social media message, such as from Twitter, etc. The transceiver is capable of receiving data from the vehicle control module and can reflect the presence of the vehicle key fob through an appropriate illumination of the display.

It would be desirable to provide a display on a seat belt to reflect the usage of the seat belt in relation to the number of miles the vehicle has been driven.

### SUMMARY OF THE INVENTION

It is an object of this invention to overcome the disadvantages of the prior art by providing a seat belt monitor system in automobiles to provide data related to the use of seat belts while the vehicle is being operated.

It is another object of this invention to provide a seat belt monitor system in the dashboard of the vehicle on directly on the seat belt buckle.

It is a feature of this invention that the seat belt monitor identifies the number of miles driven while the driver's seat belt was connected.

It is an advantage of this invention that the number of miles during which the vehicle is driven while the seat belt is connected is compared to the total number of miles that the vehicle is driven.

It is another feature of this invention that the seat belt monitor system can be coupled to a data line in order to report on a periodic basis the seat belt usage to the operator's insurance company.

It is another advantage that the data line can be provided by a cellular phone that can be coupled to the seat belt monitor system via a cable connected to a USB port, or wirelessly connected.

It is still another feature of this invention that the cellular phone can be provided with an application display that will show the data related to the seat belt usage and provide for an upload function to send such data to a recipient, such as an insurance company.

It is yet another advantage of this invention that the seat belt usage monitor can be associated with other seat belts in the vehicle besides the driver's seat belt so that the total number of miles in which someone is seated in the vehicle can be compared to the number of miles that the seat belt was used for that vehicle seat while someone was occupying that vehicle seat.

These and other objects, features and advantages can be accomplished according to the instant invention by providing a seat belt usage monitor that identifies the number of miles driven in a vehicle while the seat belt was connected in comparison with the total number of mile driven in the vehicle. The seat belt usage monitor can be displayed to the operator by a screen incorporated into the seat belt buckle or on a display monitor incorporated into the dashboard of the vehicle. The seat belt usage monitor system will track the number of miles driven while the seat belt is connected and make a comparison to the total number of miles driven by the vehicle. An application program on the operator's cellular phone corresponding to the seat belt usage monitor can be connected to the seat belt usage monitor system to transfer the usage data to the cellphone display, and to permit the function of uploading the data to a recipient selected by the operator, such as the operator's insurance company.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a photograph showing a perspective view of a seat belt buckle cooperable with a seat belt latch plate and incorporating the principles of the instant invention to reflect the number of miles the seat belt has been engaged while the vehicle has been operated;

FIG. 2 is a photograph showing a perspective view of the seat belt buckle apparatus as shown in FIG. 1, but reflecting a trip odometer on the display, similar to the trip display used on the vehicle;

FIG. 3 is a photograph showing an elevational view of the vehicle display reflecting the trip odometer information corresponding to the seat belt display shown in FIG. 2;

FIG. 4 is a photograph showing a latch plate for engagement with the seat belt buckle shown in FIGS. 1 and 2; and

FIG. 5 is a representative schematic view of a cellular phone on which is installed an app presenting a system for monitoring the usage of the seat belt in a vehicle.

### DETAILED DESCRIPTION OF THE PREFERRED EMBODIMENT

Referring now to the drawings, the seat belt buckle apparatus incorporating the principles of the instant invention can best be seen. The seat belt buckle 10 is operable as a conventional seat belt buckle in that a latch plate 13 is inserted into the opening 12 whereupon a spring-biased latch mechanism engages the latch plate 13 in a manner well known in the art until the release mechanism 14 is depressed to release the engagement between the latch mechanism and the latch plate 13 to enable the latch plate 13 to be removed from the seat belt buckle 10 in a normal, conventional manner. As is well known to one of ordinary skill in the art, the engaged seat belt encircles the occupant of the seat and prevents the occupant from being thrown from the seat in certain situations, including a crash of the vehicle. Each seating position of each vehicle is provided with a seat belt, which will include a seat belt buckle 10 and an engagable latch plate 13.

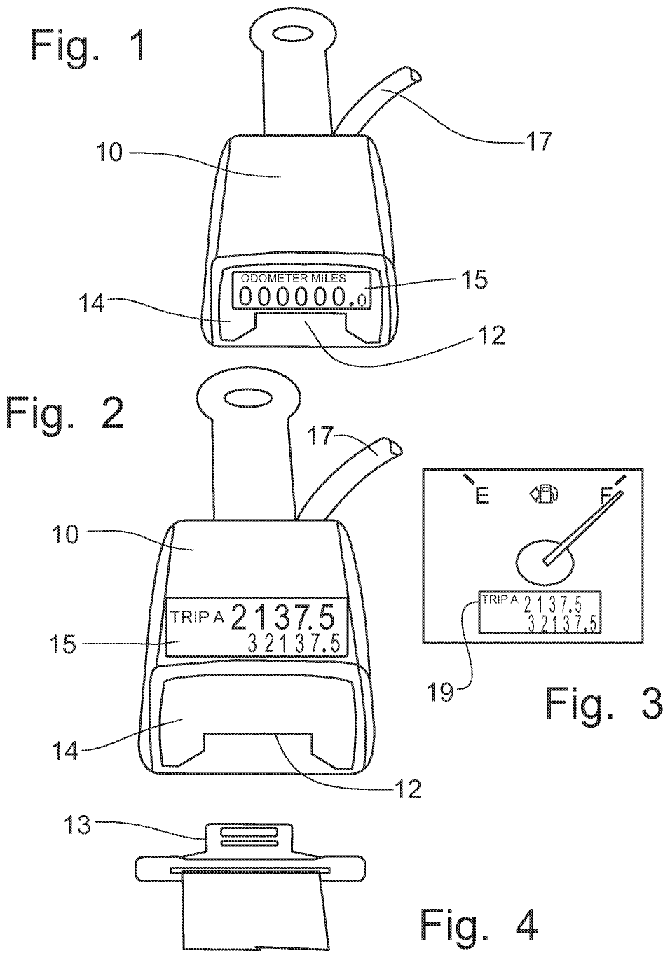

Preferably, the seat belt buckle 10 is provided with a display 15 which is preferably located immediately above the release mechanism 14 so as to be visible above the latch plate 13 when engaged with the buckle 10, as shown in FIG. 2, but could also be incorporated into the release mechanism 14, as is depicted in FIG. 1. This display 15 can be of any known construction as long as the display 15 is capable of displaying the information relating to the usage of the seat belt as is described in greater detail below. The seat belt buckle 10 also includes a wiring harness 17 that provides a connection to electrical power and to the vehicle computer. Through this wiring harness 17, the seat belt buckle 10 and the vehicle computer (not shown) can both transmit and receive information, such as when the vehicle is powered and moving, when the latch plate 13 is engaged with the seat belt buckle 10, what the vehicle odometer displays, etc.

The seat belt buckle 10 could contain a microprocessor having a memory function and a data processing function, but since the vehicle computer already has such functions, there is no significant reason for the seat belt buckle 10 to have duplicate capabilities, although as a retrofit for older automotive vehicles not having an adequate vehicle computer, an embodiment having the microprocessor built into the seat belt buckle 10 would be desirable.

The microprocessor, whether incorporated into the seat belt buckle 10 or a dedicated portion of the vehicle computer, would be operable to receive signals from the vehicle indicating the powering of the vehicle, and thus the computer, and also the movement of the vehicle, recording the number of miles that the vehicle is being driven, and storing this data in a digital format. In addition, the seat belt buckle 10 generates a signal when the latch plate 13 is engaged with the seat belt buckle 10, which is usually in conjunction with a signal from the seat reflecting the presence of a person in the seat that should be retained by the seat belt. Presently, that signal of engagement of the seat belt tells the vehicle computer so that the seat belt light on the control panel is turned off. That signal of engagement of the seat belt can also be used by the vehicle computer, according to the principles of the instant invention, to record the numbers of miles the vehicle is driven while the seat belt is properly engaged.

The computer can have a number of settings to reflect seat belt usage. For example, the display 15 can receive data from the vehicle computer that depicts on the display 15 the number of miles the vehicle has been driven (i.e., the odometer reading) and/or the number of miles that the vehicle has been driven while the seat belt has been properly engaged. The display could also show a percentage of the number of miles the vehicle has been driven with the seat belt properly engaged as compared to the total number of miles reflected on the odometer. As is reflected in FIGS. 2 and 3, the display 15 can reflect seat belt usage on a resettable trip odometer 19 reading, either in terms of absolute numbers of miles, or a percentage of the total number of miles driven since the last reset of the trip odometer 19.

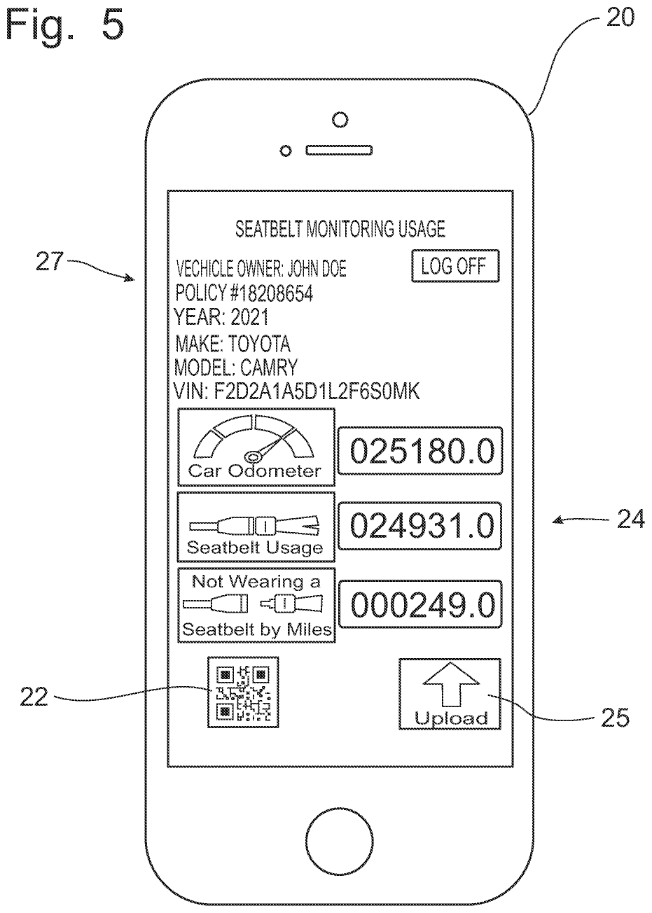

Referring now to FIG. 5, a schematic representation of an App for monitoring the usage of the seat belt 10, as described with respect to FIGS. 1-4 above, can best be seen. The App provides a display on the cellular phone 20 that is electronically coupled to the system incorporated into the seat belt 10 in order to receive a signal therefrom for display on the cellular phone 20. Preferably, this electronic coupling can be attained by the connection of a USB cable connected at one end to a port (not shown) on the cellular phone 20 and to a port (not shown) at an accessible location on the seat belt 10 structure, or to a USB port operably connected to the car odometer that is in turn electronically connected to the seat belt 10. Alternatively, the electronic coupling can be a wireless connection. Further, the mileage data can be transferred from the seat belt 10 to the App display through use of the QR code 22 on the App display.

This electronic coupling of the cellular phone 20 to the seat belt 10 will upload the mileage data onto the app display, as shown in FIG. 5. As is representatively depicted on the right side of the display on the cellular phone 20, the App displays the mileage data 24 with respect to the number of miles driven, the number of miles driven with seat belt buckled, and the mathematical difference. This side of the representative display at 27, which information can be stored in the App, or in the vehicle or seat belt 10 and transmitted to the App, can then be uploaded to the insurance company, in intervals, such as six months or annually, as required by pressing the upload button 25 on the App display. Alternatively, the mileage data 24, along with the car and owner information as depicted on the left mechanic inspecting the vehicle, whether an independent or dealer shop, could provide the information through a similar App function, particularly if the owner inform is transmitted from the vehicle to the App function.

By connecting the phone to the Buckle using a USB cable, you can open the App and upload your odometer reading mileage on both the screens on the seat belt buckle and dashboard of the vehicle and your car information. The mileage can be uploaded to the insurance company at periodic intervals, such as every six months, or every year, as requested. Also, mechanic shops can upload both mileages on the seat belt buckle and on the dashboard every year to the insurance company, such as upon inspection of the vehicles.

Although the principles of the instant invention are preferably utilized on the driver's seat and corresponding seat belt assembly, each seat belt assembly in the vehicle can be monitored for proper seat belt usage. Using as an example a seating position in the second row of seating, i.e., behind the driver's seat, the seat belt buckle 10 can have the same display reflecting proper seat belt usage. The logic, however, would need to be slightly different. While the driver's seat is necessarily occupied when the vehicle is being operated, and the comparison of the seat belt usage at the driver's seat can be a function of the number of miles the vehicle has been driven, the same relationship between seat belt usage and the number of mile the vehicle has been driven does not apply to the seat belt usage of passenger seats, as the vehicle can be operated without any passengers other than the driver.

For all of the passenger seats, the microprocessor, whether incorporated into the seat belt buckle 10 or in the vehicle computer, needs to reflect the number of miles driven while the particular passenger seat was being utilized. Thus, the microprocessor will be programmed to only count miles driven if the seat sensor for that particular passenger seat has been activated to define the presence of a passenger in that seat. Then, the microprocessor will utilize the signal from the engagement of the latch plate 13 and the seat belt buckle 10 for that corresponding passenger seat to determine the number of miles that proper usage of the seat belt for that passenger seat has occurred. Accordingly, the display 15 can show the number of miles driven during which that passenger seat has been occupied, along with the number of miles that the seat belt has been properly utilized during those driven miles. As previously noted, the display can reflect the percentage of proper usage, or depict the corresponding data for the vehicle since the previous trip odometer has been reset.

The operating panel on the vehicle dash could include a display area where this same data reflecting proper seat belt usage is displayed so that the information shown on the seat buckle display 15 is also shown on the vehicle operating panel. This information relating to proper seat belt usage could be an important factor in the assessment of insurance rates for coverage of the vehicle and the occupants thereof. Parental control of young drivers can be an additional use for the instant invention to provide confirmation that the young drivers are properly deploying their seat belts.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. A seat belt monitor for use in an automotive vehicle, comprising:
a seat positioned in an operator's cabin of the automotive vehicle;
a sensor associated with said seat to determine the presence of an occupant positioned in said seat;
a seat belt corresponding to said seat, said seat belt including a seat belt buckle and a latch plate engagable with said seat belt buckle to releasably secure said latch plate to said seat belt buckle; and
an electronic display mounted on said seat belt buckle, said display being operatively connected to a microprocessor that identifies and stores the number of miles the automotive vehicle is driven and the number of miles during which the automotive vehicle is driven while the latch plate is engaged with the seat belt buckle, said display providing a visible output while said automotive vehicle is operatively powered to reflect proper usage of said seat belt during operation of said automotive vehicle.

2. The seat belt monitor of claim 1 wherein said seat is a driver's seat which is occupied whenever the automotive vehicle is driven.

3. The seat belt monitor of claim 2 wherein said operator's cabin includes multiple passenger seats utilized by passengers seated within said automotive vehicle while said driver's seat is occupied.

4. The seat belt monitor of claim 3 wherein each said passenger seat has a seat belt and display associated therewith, said microprocessor further identifying and storing the number of miles driven while an occupant is seated in one of said passenger seats and the number of miles driven during which the seat belt for the passenger seat is properly engaged, said display showing date reflecting the utilization of the seat belt on each occupied passenger seat.

5. The seat belt monitor of claim 4 wherein said display is operable to depict:
(a) the number of miles driven while a given seat is occupied compared to the number of miles driven while the seat belt corresponding to the given seat is properly engaged;
(b) the ratio of number of miles in which a seat belt for said given seat is properly utilized versus the number of miles driven while said given seat is occupied; or
(c) the data concerning proper utilization of the seat belts for said given seat for a trip duration defined as the number of miles driven since a trip odometer of said automotive vehicle has been reset.

6. The seat belt monitor of claim 4 wherein said seat belt buckle further includes a release mechanism that is operable to affect a disengagement of said latch plate from said seat belt buckle, said display is mounted on said seat belt buckle above said release mechanism.

7. The seat belt monitor of claim 1 wherein said seat belt buckle further includes a release mechanism that is operable to affect a disengagement of said latch plate from said seat belt buckle, said display is mounted on said seat belt buckle on said release mechanism.

8. A method of monitoring seat belt usage in an automotive vehicle having an operator's cabin with a driver's seat and at least one passenger seat, each said seat having a sensor determining an occupation of the corresponding seat, each seat having a seat belt including a latch plate and a seat belt buckle, comprising the steps of:
identifying and storing data in a microprocessor operatively coupled to said seat belt buckle for the number of miles driven while any given seat is occupied and for the number of miles driven while the seat belt corresponding to said given seat is properly engaged; and
displaying data on a display, said data reflecting the usage of the seat belt while said automotive vehicle was being driven.

9. The method of monitoring seat belt usage of claim 8 wherein said data being displayed shows the total number of miles driven in the car and the total number of miles during which the seat belt was properly engaged.

10. The method of monitoring seat belt usage of claim 9 wherein said data is displayed on a screen embedded in the seat belt buckle.

11. The method of monitoring seat belt usage of claim 9 wherein said data is displayed on a screen incorporated into the vehicle dashboard.

12. The method of monitoring seat belt usage of claim 9 wherein said data is displayed on a screen of a cellular phone through use of an App program stored in said cellular phone.

13. The method of monitoring seat belt usage of claim 12 wherein said App program includes the capability to upload said data to a remote recipient.

14. The method of monitoring seat belt usage of claim 9 wherein said step of identifying and storing data is applied to the seat belt corresponding to the vehicle driver seat.

15. The method of monitoring seat belt usage of claim 14 wherein said step of identifying and storing data is independently applied to all seat belts in said vehicle, said step of displaying data being selectable with respect to each seat belt deployed in said vehicle.
